(19) United States
(12) Patent Application Publication
(10) Pub. No.: US 2013/0074937 A1
(43) Pub. Date: Mar. 28, 2013

(54) Medical Gas Switchover Manifold

(71) Applicant: Albert Wing, La Canada, CA (US)

(72) Inventor: Albert Wing, La Canada, CA (US)

(21) Appl. No.: 13/247,057

(22) Filed: Sep. 28, 2011

(51) Int. Cl. F17D 3/03; F17D 1/02

(52) U.S. Cl. 137/1; 137/266

(57) ABSTRACT

A switchover manifold for selectively connecting one of a plurality of compressed gas vessels to a point of use such that the supply of compressed gas remains uninterrupted even as the compressed gas vessels are opened and closed to the point of use for renewal of depleted compressed gas vessels. The switchover manifold has an inlet for each gas vessel all in communication with a utilization outlet, and an externally operated valve which opens only one compressed gas vessel to the utilization outlet at any one time. The manifold may be utilized in conjunction with a gas bottle cart. The gas bottles may be medical side D bottles being used in association with a medical procedure comprising insufflation.

### FIELD OF THE INVENTION

The present invention relates to control of medical gases being dispensed from plural gas storage tanks, and more particularly to an apparatus which both enables plural tanks to be connected together and also enables a user to select which tank is actively connected to medical apparatus which uses the stored medical gases.

### BACKGROUND OF THE INVENTION

Medical procedures may utilize medical gases which are stored under pressure in dedicated pressure vessels. One example is insufflation apparatus which may be connected to a compressed gas bottle or other dedicated vessel.

As a medical procedure progresses, the gas may become depleted. It may be inefficient if not hazardous to a procedure should the patient become deprived of medical gas. It is undesirable to interrupt a medical procedure to disconnect and replace a depleted compressed gas bottle. There exists a need to be able to renew compressed gas bottles without interrupting a medical procedure.

### SUMMARY OF THE INVENTION

The present invention provides a manifold which enables immediate switchover of gas supply from one compressed gas bottle to another, while maintaining the supply of compressed gas uninterrupted. Also, the switchover manifold is provided with pressure gauges arranged to indicate immediately and readily the remaining pressure and hence volume of contents for each of several compressed gas bottles connected thereto. The switchover manifold has for example a three way valve arranged to make active connection of any one selected compressed gas bottle to that apparatus which actually utilizes the compressed gas.

The switchover manifold may be mounted on a gas bottle cart to support medical gases for example. The gas bottles may be size D medical gas bottles. The associated procedure may be a medical procedure such as surgery, comprising a step of insufflation utilizing a gas supply the continuity of which is assured by utilization of plural gas bottles which may be connected to the switchover manifold and periodically replaced without interrupting the medical procedure.

It is an object of the invention to provide a way of replacing depleted compressed gas bottles in the course of a medical procedure without discontinuing the supply of compressed gas from the medical procedure.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side view of apparatus of the invention.

FIG. 2 is an exploded, enlarged side detail view of the top of FIG. 1.

FIG. 3 is an enlarged side view of the central component of FIG. 2.

### DETAILED DESCRIPTION

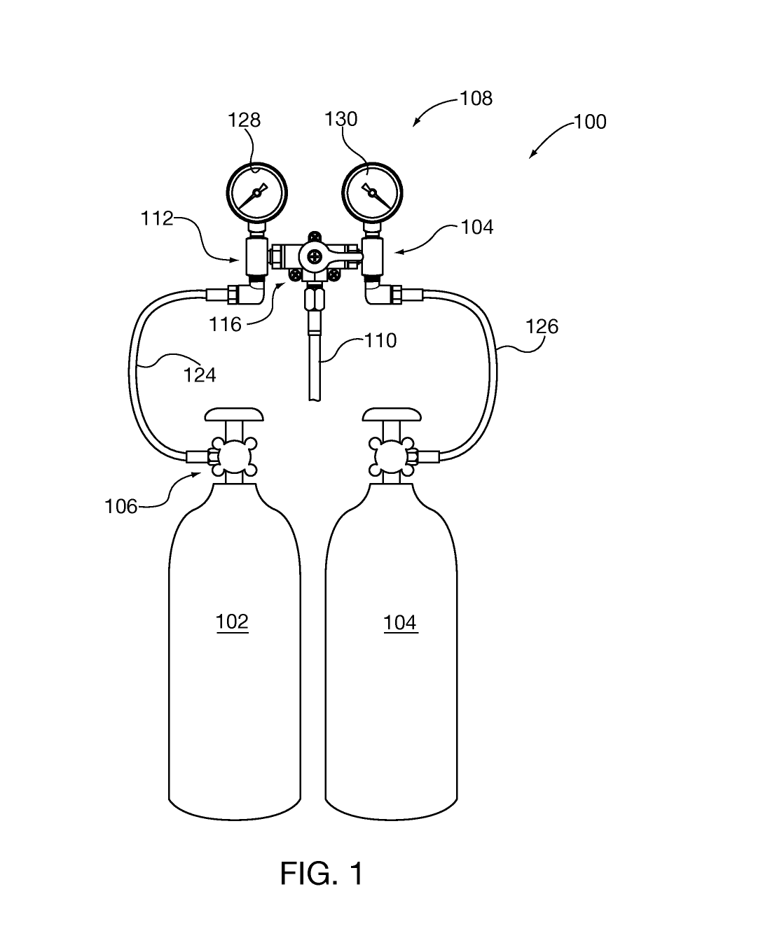

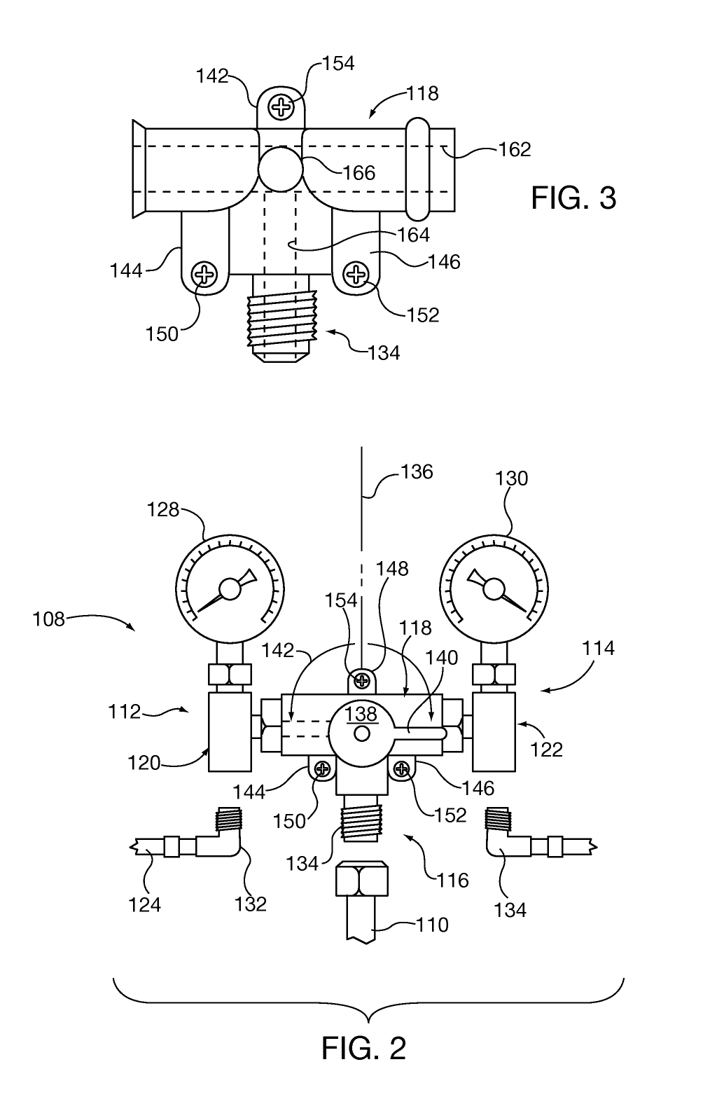

Referring first to FIGS. 1 and 2, according to at least one aspect of the invention, there is shown apparatus 100 for enabling a compressed gas supply to remain continuously available to a procedure which utilizes compressed gas, while enabling replacement of depleted compressed gas storage vessels in the course of the procedure without resulting in any interruption to the supply of compressed gas to the procedure. An advantageous example of a procedure which benefits from the invention is a surgical procedure requiring insufflation, although obviously, other procedures may also utilize the invention.

The apparatus 100 may comprise a first compressed gas storage vessel 102 containing a gas and at least one second compressed gas storage vessel 104. As employed herein, the terms “compressed gas storage vessel” and “gas bottle” will be utilized interchangeably, unless context dictates otherwise. Because the invention contemplates assuring a constant supply of gas, it follows that the gas contained within the first and second gas storage vessels 102, 104 will be identical or alternatively, functionally equivalent. The compressed gas storage vessel 102 may be a conventional compressed gas bottle having a mechanical connector 106 adapted to establish a delivery path for compressed gas stored within the first compressed gas storage vessel 102. The compressed gas storage vessel 104 may have the same functional and structural features.

Gas obtained selectively from one of the compressed gas storage vessels 102 or 104 is discharged to a utilization hose 110 which may be part of or may be connected to an insufflator (not shown) or other apparatus using the gas being dispensed. The reason for selective discharge of gas is to facilitate replacement of the compressed gas storage vessels 102, 104 as each becomes depleted. Depletion may signify that pressure falls below a predetermined pressure value, and thus the gas may not be fully exhausted when it is regarded as depleted. To this end, only one compressed gas storage vessel 102 or 104 is actively placed in communication with the utilization hose 110, while the remaining compressed gas storage vessel 104 or 102 is mechanically connected, but in a manner in which gas contained therein is not in communication with the utilization hose 110.

Actual communication between the compressed gas storage vessels 102, 104 and the utilization hose 110 is managed by a switchover manifold 108 which is disposed to establish flow paths from the first compressed gas storage vessel 102 and the second gas storage vessel 104 to the point of use or to conduits ultimately leading to the point of use. The switchover manifold 108 comprises a body 118 which may incorporate an internal three-way or “tee” shaped passage which extends to a first supply inlet 112 associated with the compressed gas storage vessel 102, a supply inlet 114 which is associated with the compressed gas storage vessel 104, and the utilization hose 110. The body 118 serves as a structural member which defines the internal passage and which supports other functional components of the switchover manifold 108. The switchover manifold 108 also comprises an internal selector valve (not visible) which is movable between a first position and at least a second position. In the first position, the selector valve is disposed to establish fluid communication selectively between the first supply inlet 112 and a utilization outlet 116 and to obstruct fluid communication between the second supply inlet 114 and the utilization outlet 116. In the second position, connection logic is reversed, the selector valve establishing fluid communication selectively between the second supply inlet 114 and the utilization outlet 116, and obstructing fluid communication between the first supply inlet 112 and the utilization outlet 116.

It may be mentioned here that the terms “supply inlet” and “utilization outlet” are conceptual rather than necessarily referring to specific apparatuses or portions of the switchover manifold 108 in that these terms designate function. Obviously, communication and obstruction functions could proceed as described even with different apparatus utilized or interposed between or among the various recited elements of the invention. Illustratively, the switchover manifold 108 may be connected to or terminate at mechanical connectors such as tee fittings 120, 122, each of which has an internal three-way or “tee” shaped passage (not shown) so as to enable connection of the switchover manifold 108 to respective hoses 124, 126, which in turn conduct gas from compressed gas storage vessels 102, 104 to the switchover manifold 108. Each hose 124 or 126 is matingly compatible with the mechanical connector of its associated compressed gas storage vessel 102 or 104, and with respective supply inlets of the switchover manifold 108, such as the tee fittings 120, 122.

The tee fittings 120, 122 may be provided as separate components which for example thread to the body 118, may be integral to the body 118, or may be provided in other ways. The tee fittings 120, 122 enable respective pressure gauges 128, 130 to be mounted to the switchover manifold 108 and connected to the internal passage of the switchover manifold 108 so as to be in fluid communication with the supply inlets 112, 114 and to monitor and annunciate pressure at each of the supply inlets 112, 114. It will be seen in FIGS. 1 and 2 that pressure gauges 128, 130 face the same direction and are thereby readily read by an observer. It will also be seen that the switchover manifold 108 is generally bilaterally symmetrical about a hypothetical plane indicated by a projection line 136 which bisects the utilization outlet. The hypothetical plane indicated by the projection line 136 is perpendicular to the plane of the drawing of FIG. 2. “Generally bilaterally symmetrical” signifies that the components are arranged in mirror image on both sides of the hypothetical plane, apart from the readouts of the pressure gauges 128, 130. Rather than literally being symmetrical, the gauges may be arranged with their readouts or gauge faces both arranged to read right to left, for example with zero values displayed at the lower left of each scale of the respective pressure gauge 128, 130. This enables immediate intuitive comprehension of pressure values being displayed by the pressure gauges 128, 130, which would be complicated were the readouts of the pressure gauges 128, 130 literally mirror images of one another.

Hoses 124, 126 may have respective integral threaded connectors 132, 134, or may comprise separate elements (not shown) to enable connection and performance as described. The same applies to the utilization hose 110, which may connect to or terminate at a mechanical connector of the 116, such as the threaded stub 134.

The various mechanical connectors of the compressed gas storage vessels 102, 104 described herein are manually connectable to the switchover manifold 108 in a way which establishes fluid-tight continuity from each of the compressed gas storage vessels 102, 104 to the internal passage of the switchover manifold 108. Fluid-tight continuity signifies that compressed gases being supplied will not leak to an objectionable extent under conditions of normal use. Threaded connections, which may for example be sealed by conventional sealing tape, fluent sealing substances, and the like, are described in illustrative capacity, although other connection schemes may be provided.

Best seen in FIG. 2, the selector valve comprises an external operating handle 138 which is disposed to move the valve (not shown, but which may be any suitable known type) between the first position and the at least second position. The operating handle 138 may comprise a pointer 140 disposed to point towards the first supply inlet 112 when the first supply inlet 112 is in fluid communication with the utilization outlet 116 and to point towards the second supply inlet 114 when the second supply inlet 114 is in fluid communication with the utilization outlet 116. Preferably, the operating handle 138 moves through a partial rotation of one hundred eighty degrees (indicated by an arrow 140) when moving between the first position and the second position. The operating handle 138 may project from the body 118 of the switchover manifold 108 in the same direction as that of the first pressure gauge 128 and the second pressure gauge 130, so that the pressure gauges 128, 130 and the operating handle 138 may be conveniently viewed from one perspective.

FIG. 2 also shows three tabs 144, 146, 148 each bearing respective holes 150, 152, 154 for receiving and retaining a fastener such as a bolt (not shown) to enable mounting of the switchover manifold 108 to a gas cart (not shown), such as an insufflation equipment cart or a gas bottle cart.

Turning now to FIG. 3, the invention may be thought of as only the switchover manifold 108, which is disposed to establish flow paths selectively from a first compressed gas source and a second compressed gas source to a point of use. That is, when thought of as only the switchover manifold 108, elements such as conduits such as the hoses 124 and 126 and even gauges such as the gauges 128 and 130 may be omitted. Considered in this way, the invention may be limited to the body 118 in which is defined an internal passage including a first inlet conduit 160, a second inlet conduit 162, and a utilization conduit 164, wherein the internal passage is configured to establish fluid communication among the first inlet conduit 160, the second inlet conduit 162, and the utilization conduit 164; a selector valve (of which only a stem 166 is seen, in end view in FIG. 3), and at least one projecting tab bearing at least one hole for receiving and retaining a fastener to enable mounting of the switchover manifold 108 to a gas cart. Although FIGS. 2 and 3 show each tab as bearing one such hole, it would be possible to provide one or more tabs bearing more than one hole. Also, the body 118 may be redesigned such that one or more holes for receiving a fastener is formed in the body in the absence of a discernible, discrete tab such as the tabs 142, 144, 146.

The selector valve may of course be the structural and functional equivalent of the valve of the switchover manifold 108 of FIG. 2 for example, and further may include a handle such as the external operating handle 138. The selector valve may be arranged such that the operating handle represented by the valve stem 166 moves through a partial rotation of one hundred eighty degrees when moving between the first position and the second position.

The switchover manifold may include one or more pressure gauges such as the pressure gauges 128 and 130, connected thereto such as by a threaded connection, or formed integrally with a body such as the body 118 redesigned from that shown herein for such a modification, while still omitting the hoses 124 and 126.

The apparatus 100 may be utilized to implement a method of operating a medical gas supply provided by more than one compressed gas storage vessel while conducting a medical procedure. The method may comprise the steps of:

providing at least two compressed gas storage vessels such as the compressed gas storage vessels 102, 104 each connected in common to a manifold such as the manifold 108 having a utilization outlet 116, and a valve disposed to open one of the at least two compressed gas storage vessels 102, 104 to the utilization outlet 116 while closing all other ones of the compressed gas storage vessels to the utilization outlet 116;

opening a first one of the compressed gas storage vessels 102, 104 to the utilization outlet 116 while the medical procedure is being conducted and is utilizing gas obtained from the utilization outlet 116, using the valve;

in a manual operation, operating the valve to close the first one of the compressed gas storage vessels 102, 104 to the utilization outlet 116 of the manifold 108 when the first one of the compressed gas storage vessels 102, 104 becomes depleted to a predetermined degree, while in a continuum of movement during the same manual operation, opening another one of the compressed gas storage vessels 102, 104 to the utilization outlet 116 of the manifold 108.

The method recited above may comprise a further step of replacing the first one of the compressed gas storage vessels 102 or 104 with a fully charged compressed gas storage vessel (not shown, but which may be similar to the compressed gas storage vessels 102, 104) while simultaneously conducting the medical procedure.

The method may comprise a still further step wherein the step of conducting a medical procedure comprises a step of practicing insufflation using gas supplied by the compressed gas storage vessels.

The present invention is susceptible to variations and modifications which may be introduced thereto without departing from the inventive principles. In one non-limiting example, although the invention has been described in terms of two compressed gas vessels 102, 104, it would be possible to modify the invention to accommodate more than two such vessels. In another non-limiting example, it would be possible to configure a manifold (not shown) which is similar in function to the manifold 108 such that the connection points serving the compressed gas storage vessels 102, 104 are spaced apart and directed so as to accommodate direct connection of the compressed gas storage vessels 102, 104 to the manifold, thereby eliminating the hoses 124, 126.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible

I claim:

1. Apparatus for enabling a compressed gas supply to remain continuously available to a procedure which utilizes compressed gas, while enabling replacement of depleted compressed gas storage vessels in the course of the procedure without resulting in any interruption to the supply of compressed gas to the procedure, comprising:
a first compressed gas storage vessel containing a gas, having a mechanical connector adapted to establish a delivery path for compressed gas stored within the first compressed gas storage vessel;
at least a second compressed gas storage vessel containing a gas which is the functional equivalent as that contained within the first compressed gas storage vessel, having a mechanical connector adapted to establish a delivery path for compressed gas stored within the second compressed gas storage vessel; and
a switchover manifold disposed to establish flow paths from the first compressed gas storage vessel and the second gas storage vessel to the point of use, comprising a body further comprising
an internal passage formed therein, a first supply inlet, a second supply inlet, and a utilization outlet, wherein the internal passage is configured to establish fluid communication among the first supply inlet, the second supply inlet, and the utilization outlet;
a selector valve which is movable between a first position and at least a second position, wherein in the first position, the selector valve is disposed to establish fluid communication selectively between the first supply inlet and the utilization outlet and to obstruct fluid communication between the second supply inlet and the utilization outlet, and in the second position, the selector valve is disposed to establish fluid communication selectively between the second supply inlet and the utilization outlet and to obstruct fluid communication between the first supply inlet and the utilization outlet, wherein
the first supply inlet terminates in a mechanical connector, the second supply inlet terminates in a mechanical connector, and the utilization outlet terminates in a mechanical connector; and
the first compressed gas storage vessel and the second compressed gas storage vessel are manually connectable to manifold in a way which establishes fluid-tight continuity from each of the first compressed gas storage vessel and the second compressed gas storage vessel to the internal passage of the switchover manifold.

2. The apparatus of claim 1, further comprising a first hose which is matingly compatible with the mechanical connector of the first compressed gas storage vessel and with the first supply inlet of the switchover manifold, and a second hose which is matingly compatible with the mechanical connector of the second compressed gas storage vessel and with the second supply inlet of the switchover manifold.

3. The apparatus of claim 1, wherein the switchover manifold is bilaterally symmetrical about a hypothetical plane which bisects the utilization outlet.

4. The apparatus of claim 1, further comprising a first pressure gauge mounted to the switchover manifold in fluid communication with the first supply inlet and disposed to monitor pressure in the first supply inlet.

5. The apparatus of claim 1, further comprising a second pressure gauge mounted to the switchover manifold in fluid communication with the second supply inlet and disposed to monitor pressure in the second supply inlet.

6. The apparatus of claim 1, wherein the selector valve comprises an external operating handle disposed to move the valve between the first position and the at least second position, and to point towards the first supply inlet when the first supply inlet is in fluid communication with the utilization outlet and to point towards the second supply inlet when the second supply inlet is in fluid communication with the utilization outlet.

7. The apparatus of claim 6, wherein the operating handle moves through a partial rotation of one hundred eighty degrees when moving between the first position and the second position.

8. The apparatus of claim 1, further comprising a first pressure gauge mounted to the switchover manifold in fluid communication with and proximate the first supply inlet and disposed to monitor pressure in the first supply inlet, and a second pressure gauge mounted to the switchover manifold in fluid communication with and proximate the second supply inlet and disposed to monitor pressure in the second supply inlet, wherein the first pressure gauge and the second pressure gauge face the same direction and are thereby readily read by an observer.

9. The apparatus of claim 8, wherein the selector valve comprises an external operating handle disposed to point towards the first supply inlet when the first supply inlet is in fluid communication with the utilization outlet and to point towards the second supply inlet when the second supply inlet is in fluid communication with the utilization outlet, and the external operating handle projects from the body of the switchover manifold in the same direction as that of the first pressure gauge and the second pressure gauge.

10. The apparatus of claim 1, wherein the body of the switchover manifold further comprises at least one tab bearing at least one hole for receiving and retaining a fastener to enable mounting of the switchover manifold to a gas cart.

11. A switchover manifold disposed to establish flow paths selectively from a first compressed gas source and a second compressed gas source to a point of use, comprising:
a body further comprising an internal passage formed therein, a first supply inlet, a second supply inlet, and a utilization outlet, wherein the internal passage is configured to establish fluid communication among the first supply inlet, the second supply inlet, and the utilization outlet;
a selector valve mounted to the body, which selector valve is movable between a first position and at least a second position, wherein in the first position, the selector valve is disposed to establish fluid communication selectively between the first supply inlet and the utilization outlet and to obstruct fluid communication between the second supply inlet and the utilization outlet, and in the second position, the selector valve is disposed to establish fluid communication selectively between the second supply inlet and the utilization outlet and to obstruct fluid communication between the first supply inlet and the utilization outlet, wherein the selector valve comprises an external operating handle disposed to move the selector valve between the first position and the at least second position, and to point towards the first supply inlet when the first supply inlet is in fluid communication with the utilization outlet and to point towards the second supply inlet when the second supply inlet is in fluid communication with the utilization outlet, and wherein the first supply inlet terminates in a mechanical connector, the second supply inlet terminates in a mechanical connector, and the utilization outlet terminates in a mechanical connector; and wherein
the body of the switchover manifold further comprises at least one tab bearing at least one hole for receiving and retaining a fastener to enable mounting of the switchover manifold to a gas cart.

12. The switchover manifold of claim 11, wherein the body of the switchover manifold further comprises at least one tab bearing at least two holes arranged in a hole pattern for receiving and retaining fasteners to enable mounting of the switchover manifold to the cart.

13. The switchover manifold of claim 11, further comprising:
a first pressure gauge mounted to the switchover manifold in fluid communication with the first supply inlet and disposed to monitor pressure in the first supply inlet; and
a second pressure gauge mounted to the switchover manifold in fluid communication with the second supply inlet and disposed to monitor pressure in the second supply inlet.

14. The switchover manifold of claim 11, wherein the operating handle moves through a partial rotation of one hundred eighty degrees when moving between the first position and the second position.

15. A method of operating a medical gas supply provided by more than one compressed gas storage vessel while conducting a medical procedure, comprising the steps of:
providing at least two compressed gas storage vessels each connected in common to a switchover manifold having a utilization outlet, and a valve disposed to open one of the at least two compressed gas storage vessels to the utilization outlet while closing all other ones of the compressed gas storage vessels to the utilization outlet;
opening a first one of the compressed gas storage vessels to the utilization outlet while the medical procedure is being conducted and is utilizing gas obtained from the utilization outlet, using the valve;
in a manual operation, operating the valve to close the first one of the compressed gas storage vessels to the utilization outlet of the switchover manifold when the first one of the compressed gas storage vessels becomes depleted to a predetermined degree, while in a continuum of movement during the same manual operation, opening another one of the compressed gas storage vessels to the utilization outlet of the switchover manifold.

16. The method of claim 15, comprising the further step of replacing the first one of the compressed gas storage vessels with a fully charged compressed gas storage vessel while simultaneously conducting the medical procedure.

17. The method of claim 15, wherein the medical procedure comprises a step of practicing insufflation using gas supplied by the compressed gas storage vessels.
